(19) United States
(12) Patent Application Publication
(10) Pub. No.: US 2008/0150854 A1
(43) Pub. Date: Jun. 26, 2008

(54) Automobile Digital Display Device

(76) Inventors: Anna Bryant, Chatsworth, GA (US); Johnny Bryant, Chatsworth, GA (US)

Correspondence Address: WILLIAMSON INTELLECTUAL PROPERTY LAW, LLC, 1870 THE EXCHANGE, SUITE 100, ATLANTA, GA, 30339, US

(21) Appl. No.: 11/718,756

(22) PCT Filed: Apr. 18, 2006
(86) PCT No.: PCT/US2006/014511

§ 371 Date: May 7, 2007

(51) Int. Cl. G09G 3/36

(52) U.S. Cl. 345/87

(57) ABSTRACT

A digital display system designed to lie mounted on the exterior of a motorized vehicle, such as the front bumper of an automobile (see FIG. 1). The digital display system includes a monitor disposed within a frame secured to the vehicle. A controller is disposed within the passenger compartment of the vehicle. The controller interfaces with the monitor and includes removable memory for storing the data image files to be displayed on the monitor.

### FIELD OF THE INVENTION

The present invention relates a digital display device for an automobile, more specifically but not by way of limitation, a programmable liquid crystal display device that is positioned on the exterior of an automobile that is used to display user selected information such as advertisements, custom images, or videos.

### BACKGROUND

Millions of automobiles are used every day in this country. Whether commuting to work, driving to the store or on a trip, people spend an average of twelve hours a week in their automobile.

A portion individuals who own automobiles choose to invest a certain amount of their disposable income in personalizing their automobiles. From custom wheels and lights to entertainment systems, investment in personalizing their automobile is a market that has seen significant growth in the last several years.

While there arc numerous LCD type displays available for entertainment systems inside vehicles that are used for everything from navigating the internet to controlling a stereo system, there is currently no device that allows an automobile owner to display a digital image on the exterior of their automobile for communication or entertainment purposes.

Another issue with current customization products for automobiles is that they do not offer a method in which organizations can engage in marketing or branding of additional products. As global competition and a flooded market place have cluttered the consumer market, organizations continuously evaluate different channels that they can use to brand their image and market their products. The short product life cycle of many automobile products creates a need for organizations to have the ability to communicate their marketing message frequently and through channels that will have the ability to capture the consumer's attention.

Accordingly, there is a need for an externally mounted digital display device for automobiles that is programmable to facilitate the transmission of customized displays that are inputted by the user to be utilized for marketing or other select purposes.

### SUMMARY OF THE INVENTION

It is the object of the present invention to provide a programmable device that is mounted to the exterior of an automobile that is used to display digital still or video images.

It is a further object of the present invention to provide a liquid crystal display monitor that is used to display images or videos in order to enhance the exterior of an individual's automobile.

Another object of the present invention is to provide a display device that is waterproof and shatter resistant.

Yet another object of the present invention is to provide a display device that can be secured to the front bumper of an automobile and is approximately the size of a license tag.

To the accomplishment of the above and related objects the present invention may be embodied in the form illustrated in the accompanying drawings. Attention is called to the fact that the drawings are illustrative only. Variations are contemplated as being a part of the present invention, limited only by the scope of the claims.

### BRIEF DESCRIPTION OF THE DRAWINGS

A more complete understanding of the present invention may be had by reference to the following Detailed Description and appended claims when taken in conjunction with the accompanying Drawings wherein:

FIG. 1 illustrates a perspective view of an embodiment of the display device of the present invention; and

FIG. 2 illustrates a perspective view of an embodiment of a controller of the present invention.

### DETAILED DESCRIPTION

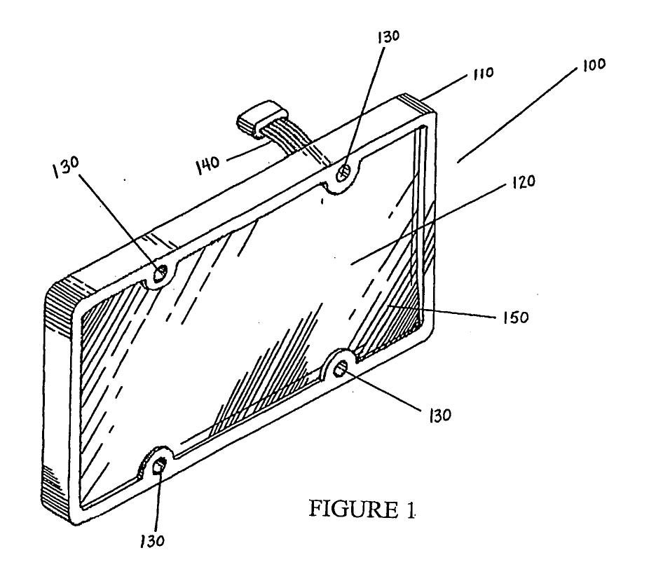

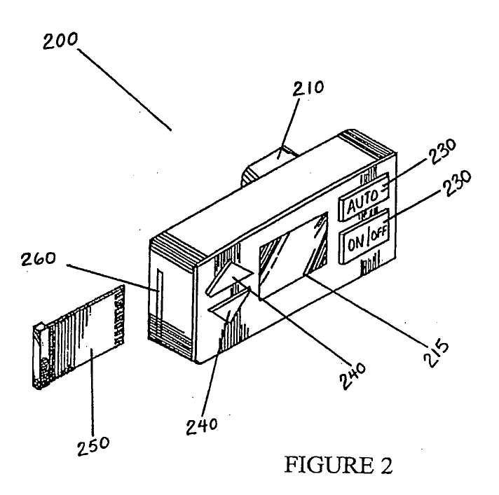

Referring now to the embodiment in FIG. 1 and 2, and wherein the various elements depicted therein are not necessarily drawn to scale, there is illustrated the components of a preferred embodiment of an automobile digital display system constructed according to the principles of the present invention.

The first component of the automobile digital display system is the external display unit or display monitor 100. The external monitor 100 comprises a frame 110. The frame 110 is circumferentially disposed on the screen 120. The frame 110 is constructed of a suitable rigid material. More specifically but not by way of limitation, the frame 110 is manufactured from a group of thermoplastics including poly ethylene, polypropylene, polystyrene, and polyvinyl chloride. The frame 110 is generally rectangular in shape, although no specific shape or dimensions are required. In the present embodiment, good results have been achieved with a frame 110 that is approximately eight inches in height by fourteen inches in length. Those skilled in the art will recognize that numerous alternative shapes could be used in place of and/or in conjunction with the frame 110 as described herein.

Mounted on the frame 110 are two opposing pairs of mounting apertures 130. Mechanical fasteners such as but not limited to bolts are journaled through the mounting apertures 110 in order to secure the external monitor 100 to the external surface of a vehicle, such as the front bumper area. Those skilled in the art will recognize that the number mounting apertures 130 could be used in place of and/or in conjunction with the four mounting apertures 130 as illustrated in FIG. 1 will vary base on a users preference. More specifically but not by way of limitation the frame 110 could be secured to a front bumper of an automobile with a mechanical fastener journaled through one mounting aperture 130.

Substantially disposed within the frame 110 is the screen 120. The screen 120 is a conventional LCD-type screen that is used for displaying images or video selected by the user. The screen 120 is secured within the frame 120 by conventional mechanical or chemical methods. The screen 120 can be manufactured using a passive matrix LCD technology or an active matrix LCD technology. It is contemplated within the scope of the present invention that the screen 120 contains 256 range subpixels in order to display color-images that have an adjustable palette that is externally controlled. Although no specific size is required for the screen 120, good results have been achieved with a screen that is approximately the size of a license tag or eight inches in height by fourteen inches in width. The screen 120 has mounted to one side a control cable 140. The control cable 140 is to be extended and connected to controller 200 and supplies the power needed to operate the screen 120. Furthermore, the control cable 140 functions to transmit the desired image data file to be projected on the screen 120.

Superposed on the screen 120 is the protective cover 150. The protective cover 150 is a transparent material in order to minimize interference with the displaying of the desired image displayed on the screen 120. The protective cover 150 is mounted to the screen 120 and the frame 110 by suitable chemical methods. The frame 110 and protective cover 150 are chemically bonded to ensure that no water can penetrate the bond. The chemical adhesion is accomplished with suitable material such as but not limited to silicon adhesives in order to ensure that the external monitor 100 is waterproof. The protective cover 150 is manufactured to be shatterproof and resistant to road debris that frequently strikes the front bumper area of an automobile. The protective cover 150 is manufactured from two layers of glass with a layer of polycarbonate material intermediate the two layers of glass. Suitable polycarbonate materials include but are not limited to, Lexan, Tuffak, and Cyrolon. Those skilled in the art will recognize that numerous different types of material could be used in place of and/or in conjunction with the materials referenced herein to achieve the desired functionality of the protective cover 150 as described herein.

Now referring to FIG. 2, there is illustrated the second component of the automobile digital display system, the controller 200. The controller 200 contains a conventional integrated circuit board that contains all of the electronics necessary to receive, store and manipulate digital image data files. Furthermore, the controller 210 functions to control other functions of the automobile digital display system such as but not limited to power management. The controller 210 comprises a housing 220 that is substantially rectangular in shape. Adjacent to the housing 220 and integrally mounted to one side is the cable receptacle 210. The cable receptacle 210 is configured to receive the second end of the control cable 140. Although the controller 200 is shown as a separate unit, it is contemplated within the scope of the present invention that the controller 200 could be configured to be mounted into the dash or console area of an automobile in a similar method as a conventional radio.

Centrally mounted to one side of the housing 220 opposite the cable receptacle 210 is the preview screen 215. The preview screen 215 is a small conventional LCD type screen that provides the user a graphical interface to select a desired image or group of images to display on the external monitor 100. The desired images are loaded into the controller 220 with the memory card 250. The memory card 250 is a conventional memory card based on EEPROM technology that allows a user to load new data files and delete selected existing data files from the memory card 250 for subsequent display on the external monitor 100. The memory card 250 interfaces with the controller via the slot 260. The slot 260 is configured to be of suitable shape to mateably connect with a conventional memory card. It is further contemplated to be within the scope of the invention that data corresponding to the photos or videos to be displayed could also be wirelessly transmitted to control unit 200, such as by Blue-Tooth™, WI-FI, or other wireless technologies.

Adjacent to the preview screen 215 are a plurality of selector buttons 240. The selector buttons 240 function as an interface for the user to navigate through the data stored on the memory card 250. The selector buttons 240 are either conventional manual switches or switches that will detect light, heat or motion.

Opposite the selector buttons 240 and adjacent to the preview screen 215 are a plurality of control buttons 230. The control buttons 230 function to power the automobile digital display system on or off. Further, the control buttons 240 function as an interface for the user to program the automobile digital display system in a random or predetermined sequence of projection of stored images from the inserted memory card 250 to be transmitted to the external monitor 100. It is also contemplated within the scope of the present invention that the control buttons 240 function to manipulate the image date files stored on the memory card 250. More specifically but not by way of limitation, the control buttons 250 could be configured to direct changes in image quality such as brightness, sharpness, color or tint.

It is contemplated within the scope of the present invention that the power source is the DC power system of the automobile. It is further contemplated within the scope of the present invention, that the power source could comprise an internal power source such as batteries mounted in the controller 200 and/or external monitor 100

Now referring to FIGS. 1 and 2, a description of the operation of the automobile digital display system is as follows. In use, the user mounts the external monitor 100 onto the front bumper of an automobile. The controller 200 is interfaced to the external monitor 100 with the control cable. The user inserts the memory card containing the data file images that are desired for projection of the external monitor 100. The user manipulates the selector buttons 240 and the control buttons 230 to program the controller 200 to project the desired data image files in a predetermined sequence resulting in the desired customization effect for the automobile. The controller 200 could alternatively be programmed to project an image from a single data image file continuously onto the external monitor 100. The user periodically reloads the memory card 250 with the desired image data files to be displayed and inserts the memory card into the controller 200 and repeats the process.

In the preceding detailed description, reference has been made to the accompanying drawings that form a part hereof, and in which are shown by way of illustration specific embodiments in which the invention may be practiced. These embodiments, and certain variants thereof, have been described in sufficient detail to enable those skilled in the art to practice the invention. It is to be understood that other suitable embodiments may be utilized and that logical changes may be made without departing from the spirit or scope of the invention. The description may omit certain information known to those skilled in the art. The preceding detailed description is, therefore, not intended to be limited to the specific forms set forth herein, but on the contrary, it is intended to cover such alternatives, modifications, and equivalents, as can be reasonably included within the spirit and scope of the appended claims.

1. A digital display system comprising:
a memory card, wherein said memory card is removable;
a controller, said controller for receiving data image files to be displayed, and wherein said controller is adapted to receive said removable memory card;
a monitor, said monitor for receiving and subsequently displaying data image files stored in said controller; and
an automobile having an external portion and an internal portion, said monitor being mounted to said external portion of said automobile and said controller being mounted within said internal portion of said automobile.

2. The digital display system recited in claim 1, and further including a frame, said frame being secured to said monitor, said frame configured to be mounted to the front bumper area of said automobile.

3. The digital display system as recited in claim 2, wherein said controller is mounted in a housing.

4. The digital display system as recited in claim 3, wherein said removable memory card is configured to interface with said housing.

5. The digital display system as recited in claim 4, wherein said monitor includes a protective cover substantially disposed thereon, said protective cover configured to protect said monitor from debris.

6. The digital display system as recited in claim 5, wherein said controller further includes a preview screen, said preview screen for viewing data image files stored on said removable memory card.

7. The digital display system as recited in claim 6, wherein said controller further includes a plurality of control buttons, said control buttons for navigating through and manipulating stored image data files on said removable memory card.

8. A digital display system with a portion configured to be placed on the exterior of an automobile, said digital display system comprising:
a monitor, said monitor being an LCD monitor, said monitor for displaying a digital image, said monitor connected to the exterior of the automobile;
a controller, said controller for controlling the operation of the digital display system including manipulating the data image being displayed on said monitor; and
a removable memory card, said removable memory card for storing user selected data image files, said removable memory card configured to removably interface with said controller.

9. The digital display system as recited in claim 8, wherein said monitor configured to be secured to the front bumper area of the automobile.

10. The digital display system as recited in claim 9, wherein said controller is disposed within the passenger compartment of the automobile.

11. The digital display system as recited in claim 10, wherein said monitor further includes a protective cover, said protective cover being two layers of glass with an intermediate polycarbonate layer.

12. The digital display system as recited in claim 11 and further including a cable for connecting said controller and said monitor.

13. The digital display system as recited in claim 12, wherein said removable memory card stores data image files and is capable of receiving additional data image files in place of a plurality of original image data files.

14. The digital display system as recited in claim 13, wherein said controller further includes a plurality of control buttons, said control buttons for navigating through and manipulating data image files stored on said removable memory card.

15. A digital display system for placement on the exterior of an automobile for displaying user selected data image files comprising:
a monitor, said monitor being an LCD monitor, said monitor for displaying a digital image, said monitor being disposed within a frame, said frame being configured to be mounted to a bumper of an automobile, said frame further including four mounting apertures;
a controller, said controller being configured with an integrated circuit board to control said digital display system and manipulate the data image files deposited therein, said controller being configured with an LCD screen, said LCD screen for previewing said data file images during the manipulation process;
a removable memory card, said removable memory card for storing user selected data image files, said removable memory card configured to removably interface with said controller, said removable memory card being capable of receiving additional data image files in place of original data image files.

16. The digital display system as recited in claim 15, wherein said controller is disposed within the passenger compartment of said automobile.

17. The digital display system as recited in claim 16, wherein said controller further includes a plurality of control buttons, said control buttons configured to provide a user interface to navigate through and manipulate the data image files stored on said removable memory card.

18. The digital display system as recited in claim 17, wherein said monitor further includes a protective cover, said protective cover being two layers of glass with a polycarbonate layer intermediate said two layers of glass.

19. The digital display system as recited in claim 18, wherein said monitor is mounted to the front bumper of said automobile.

20. The digital display system as recited in claim 19, wherein said monitor is eight inches in height and fourteen inches in length.
